(19) United States
(12) Patent Application Publication
(10) Pub. No.: US 2010/0151122 A1
(43) Pub. Date: Jun. 17, 2010

(54) METHOD FOR FORMING PHOSPHOR COATING

(75) Inventors: PING-YU CHEN, Chu-Nan (TW); NAI-WEN ZHANG, Chu-Nan (TW); YING-CHIEH LU, Chu-Nan (TW); KUO-FENG CHIANG, Chu-Nan (TW); WEN-JANG JIANG, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/504,800

(22) Filed: Jul. 17, 2009

(30) Foreign Application Priority Data
Dec. 11, 2008 (CN) 200810306164.1

(51) Int. Cl. B05D 1/18

(52) U.S. Cl. 427/157

(57) ABSTRACT

An exemplary method for forming phosphor coating includes: providing a substrate; forming a first hydrophilic film on the substrate, the first film being soluble in water; forming a second lipophilic film on the first film, the second film comprised of a phosphor material; submerging the substrate having the first film and the second film formed thereon into water, so that the first film is dissolved in water and the second film is floated on surface of the water; and dipping a light source into the second film to forming a phosphor coating on the light source.

### BACKGROUND

1. Technical Field

The present disclosure generally relates to a method for forming phosphor coating, and particularly to a method for forming a phosphor layer on a light source.

2. Discussion of Related Art

Light emitting diodes (LEDs) are one kind of semiconductor element. Nowadays, LEDs are used extensively as light sources for illuminating devices, due to their high luminous efficiency, low power consumption and long work life.

A typical light source module uses a blue LED as an initial light source to produce a white light. The blue light emitted from the blue LED strikes phosphor material coated within the light source module to generate a yellow secondary color light. The combination of the yellow and residual blue light produces a white light. The efficiency of the light mixing is determined by the uniformity of the phosphor coating.

However, because the phosphor is usually packaged within LED, it is difficult to apply it evenly. As a result, the white light may have a yellow halo and not evenly illuminate. Although phosphor can be evenly coated on LED chips by injection molding, the method is only suitable for LED chips that are distributed on a plane.

Therefore, what is needed is a method for forming phosphor coating capable of overcoming the above described shortcomings.

### BRIEF DESCRIPTION OF THE DRAWINGS

Many aspects of the present method for forming phosphor coating can be better understood with reference to the following drawings. The components in the drawings are not necessarily drawn to scale, the emphasis instead being placed upon clearly illustrating the principles of the present method for forming phosphor coating. Moreover, in the drawings, like reference numerals designate corresponding parts throughout certain views.

FIG. 1 is a flowchart of a method for coating phosphor, according to an exemplary embodiment.

FIG. 2 is a schematic view of a substrate with two films thereon, according to the method of FIG. 1.

FIG. 3 is a schematic view showing a dipping stage of the method of FIG. 1.

### DETAILED DESCRIPTION OF EMBODIMENTS

Reference will now be made to the drawings to describe embodiments of the present method for forming phosphor coating, in detail.

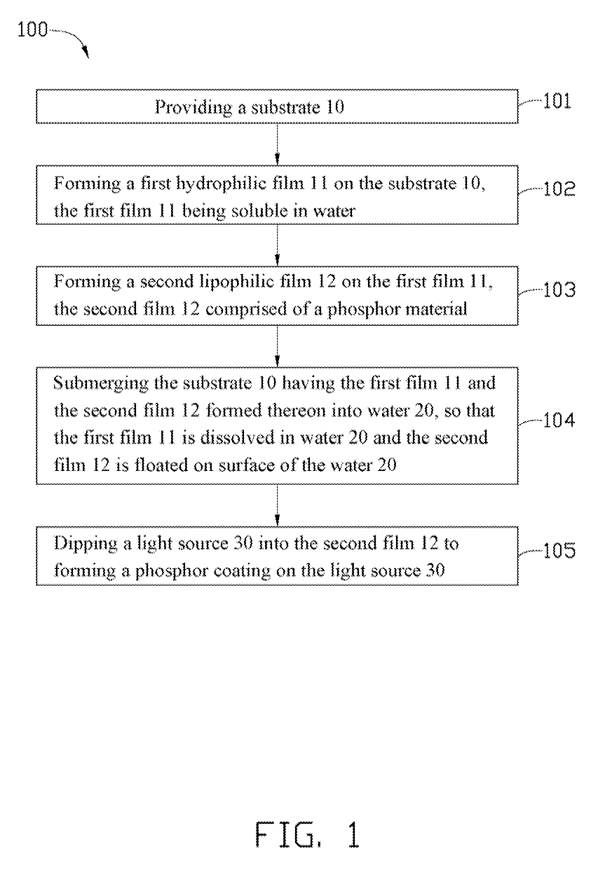

Referring to FIGS. 1-3, a method for forming phosphor coating 100, according to an exemplary embodiment, includes:
Step 101: providing a substrate 10;
Step 102: forming a first hydrophilic film 11 on the substrate 10, the first film 11 being soluble in water;
Step 103: forming a second lipophilic film 12 on the first film 11, the second film 12 comprised of a phosphor material;
Step 104: submerging the substrate 10 having the first film 11 and the second film 12 formed thereon into water 20, so that the first film 11 is dissolved in water 20 and the second film 12 is floated on surface of the water 20; and
Step 105: dipping a light source 30 into the second film 12 to forming a phosphor coating on the light source 30.

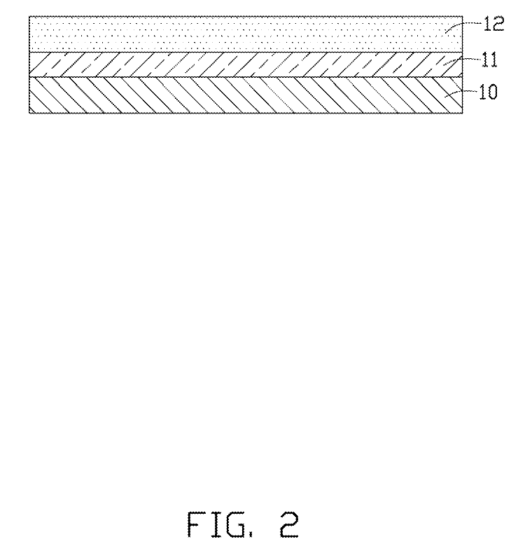

In step 101, in an exemplary embodiment, the substrate 10 (as illustrated in FIG. 2) is generally board shaped and includes a smooth surface 101. In this embodiment, the substrate 10 is a sheet of release paper.

In step 102, the first film 11 is formed on the surface 101 of the substrate 10. The thickness of the first film 11 is in the range from about 30 microns to 80 microns. In an exemplary embodiment, the first film 11 is made of polyvinyl alcohol (PVA). PVA film has strong adhesive and retractility qualities. Because PVA film has both hydrophilic hydrophobic qualities, it can provide great interfacial activity.

In step 103, a lipophilic material is mixed with a phosphor, and the admixture is coated onto the first film 11 to form the second film 12. The thickness of the second film 12 is in the range from about 50 microns to 250 microns. The second film 12 is formed on the first film 11 by spray coating, brush coating or roller brushing. In an exemplary embodiment, the second film 12 is polyurethane (PU). Because PU is a polymer, it cannot be easily dissolved in a nonpolar solvent, and can resist acid and alkali. PU imbues the second film 12 with the ability to withstand a wide temperature range, usually in the range from about 50 degrees centigrade below zero to 150 degrees centigrade.

In step 104, the substrate 10 having the first film 11 and the second film 12 formed thereon is submerged in purified water 20. The first film 11 dissolves in the water 20. Thus the second film 12 is separated from the first film 11 and is floated on the surface of the water 20.

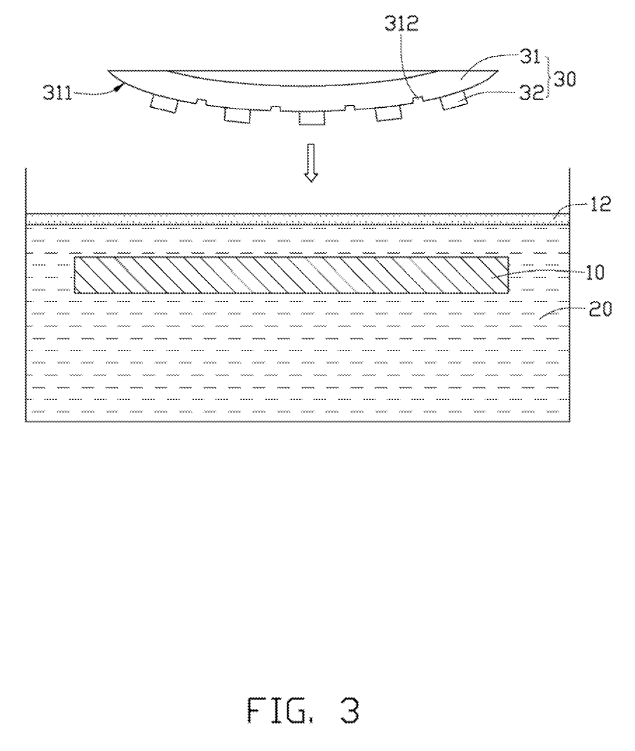

In step 105, in an exemplary embodiment, the light source 30 (as illustrated in FIG. 3) comprises a bracket 31 and a plurality of light emitting components 32 arranged on an arced surface 311 of the bracket 31. A plurality of recesses 312 is formed in the curved surface 311 of the bracket 31. The light emitting components 31 and the recesses 312 are arranged alternately therebetween. The light emitting components 31 can be selected from the group consisting of light emitting diodes (LEDs), LED chips and LED wafers. In this step, the light source 30 is moved toward the surface of the water 20 to contact the second film 12, thus the second film 12 can be evenly coated on the light emitting components 31 of the light source 30. The recesses 312 are configured for discharging gas to strengthen the adhesive force between the second film 12 and the light emitting components 31.

In the present exemplary embodiment, the light source 30 can be heated , for example, in a furnace, to further strengthen the adhesive force between the second film 12 and the light emitting components 31. In this embodiment, the light source 30 is heated to a temperature in the range from about 50 degrees centigrade to 150 degrees centigrade. After heating the light source 30, the second film 12 can be coated on the light source 30 evenly and firmly.

The method for forming phosphor coating 100 can evenly form a phosphor layer on light emitting components which are distributed on an arced surface or a planer surface.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for forming a phosphor layer on a light source, the method comprising:
providing a substrate;
forming a first hydrophilic film on the substrate, the first film being soluble in water;
forming a second lipophilic film on the first film, the second film comprised of a phosphor material;
submerging the substrate having the first film and the second film formed thereon into water, so that the first film is dissolved in water and the second film is floated on surface of the water; and
dipping a light source into the second film to forming a phosphor coating on the light source.

2. The method of claim 1, wherein the substrate is a sheet of release paper.

3. The method of claim 1, wherein the first film is made of polyvinyl alcohol.

4. The method of claim 1, wherein the thickness of the first film is in the range from about 30 microns to 80 microns.

5. The method of claim 1, wherein the second film comprises polyurethane.

6. The method of claim 1, wherein the thickness of the second film is in the range from about 50 microns to 250 microns.

7. The method of claim 1, wherein the light source is selected from the group consisting of a light emitting diode, a light emitting diode chip and a light emitting diode wafer.

8. The method of claim 1, wherein the light source comprises a plurality of light emitting components, the light emitting components arranged on a curved surface of a bracket.

9. The method of claim 8, wherein a plurality of recesses is formed in the curved surface of the bracket, the recesses and the light emitting components are arranged alternately therebetween.

10. The method of claim 1, further comprising heating the light source after the dipping step.

11. The method of claim 10, wherein the light source is heated to a temperature in the range from about 50 degree centigrade to 150 degree centigrade.

12. The method of claim 1, wherein the second film is formed on the first film by spray coating, brush coating or roller brushing.
